(19) United States
(12) Patent Application Publication
(10) Pub. No.: US 2015/0300125 A1
(43) Pub. Date: Oct. 22, 2015

(54) HEAT INSULATED STRING SEGMENT

(71) Applicant: TMK-PREMIUM SERVICES LLC, Moscow (RU)

(72) Inventors: Sergey Alexandrovich REKIN, Moscow (RU); Nikolai Vladimirovich TRUTNEV, Kamensk-Uralsky (RU); Alexander Igorevich GREHOV, Kamensk-Uralsky (RU); Nadezhda Tahirovna TIHONTSEVA, Kamensk-Uralsky (RU); Mihail Naumovich LEFLER, Kamensk-Uralsky (RU); Igor Urievich PYSHMINTSEV, Ekaterinburg (RU); Vladimir Ivanovich KUZNETSOV, Chelyabinsk (RU); Petr Leonidovich KOPYLOV, Chelyabinsk (RU); Andrey Alexandrovich KRIVOSHEEV, Chelyabinsk (RU); Vsevolod Vladimirovich CHEREPANOV, Moscow (RU); Nail Anatolievich GAFAROV, Moscow (RU); Vladimir Ivanovich NUKHIN, Moscow (RU); Sergey Nikolaevich MENSHIKOV, Tyumen Region (RU); Igor Sergeevich MOROZOV, Tyumen Region (RU); Roman Urievich DASHKOV, Tyumen Region (RU); Sergey Gennadievich VERIKOV, Sverdlovsk Region (RU); Boris Urievich SHCHERBAKOV, Rostov Region (RU); Arkadii Petrovich BYKOV, Sverdlovsk Region (RU); Yuri Fedorovich EMELIANOV, Rostov Region (RU); Ilya Viktorovich CHERNYH, Sverdlovsk Region (RU); Andrey Gennadievich FILIPPOV, Moscow (RU)

(73) Assignee: TMK-PREMIUM SERVICES LLC, Moscow (RU)

(21) Appl. No.: 14/361,809

(22) PCT Filed: Dec. 18, 2012
(86) PCT No.: PCT/RU2012/001076

§ 371 Date: May 30, 2014

(30) Foreign Application Priority Data
Dec. 20, 2011 (RU) 2011151821

(51) Int. Cl. E21B 36/00; E21B 17/00; F16L 59/065

(52) U.S. Cl. CPC E21B 36/003; F16L 59/065; E21B 17/00

(57) ABSTRACT

Insulated string segment contains an inner pipe with reinforcements on its ends, centrators located on it, insulation and gas absorbers, outer pipe with external thread on its ends and connecting coupling. Outer pipe is produced with pressure isolated valve providing creation of 10⁻⁴-10⁻³ mm of Mercury vacuum in the interpipe space. Steel insertions made in a form of spools and welded to inner and outer pipes with vacuum-tight seams are located in the interpipe space so as to provide groove produced on the insertion and an outer pipe create hollow. Centrators are made in a form of clamps with two parts closely tightened to each other with inner surface made with friction properties. The string is useful in oil and gas extraction for forcing the heat-transfer agent into a layer. Reduction of heat loss during passage through the string and improvement of service ability of the string are provided.

The invention refers to oil and gas extraction and can be used for construction of heat insulated strings for forcing heat-transfer agents into the layer for heavy oil extraction as well as for heat insulation of other pipe-lines used for heat-transfer agent transportation.

There is known heat insulated string containing inner pipes, connected by a coupling, and outer pipes. Along with this one of ends of each inner pipe is equipped with sliding transferring faucet and insulation bridges and multi-layer reflective insulation located between the inner and outer pipes (SU 740932, 15.06.1980, E21B 17/00).

The shortcomings of abovementioned heat insulated string are the following: high heat loss induced by amounts of air located in the Interpipe space of the string which is characterized by relatively high heat conductivity, besides that construction of such heat insulated case does not prevent heat-transfer agent from penetrating the Interpipe space which results in heat conductivity of the case.

There is known heat insulated string segment referred to as a prototype containing inner pipe made with upset shaped ends, outer pipe pressed along the axis to shorten 9-12 mm before the mounting and equipped with external tapered buttress and connecting coupling on its ends. Inner and outer pipes of the string segment are produced of the same material and are connected with their end faces with vacuum-tight seams. Inner pipe is produced with multi-layer reflective insulation, kept by the centrators made in a form of rings. Gas absorber is located between the insulation layers, and 10⁻⁴-10⁻³ mm of Mercury vacuum is created in an Interpipe space by air pumping out through the valve made on an outer pipe (RU 2129202 Cl, 20.04.1999, E21B 17/00, E21B 36/00).

This heat insulated string has following shortcomings: the inner pipe upset ends don't interfit well with the outer pipe as it is hardly possible to organize its precise production. Along with during mounting of the string segment gaps between the pipes can amount to 5-6 mm per side, when the allowed gaps are 0.5-1.5 mm this results in degradation of welding connection quality and in the course of time—in depressurization of Interpipe space and sequently results in degradation of heat insulating and service properties of the string.

Besides that this type of construction does not provide sufficient attachment of centralizers to insulation surface which causes its shifting and insulation integrity breakage and degradation of heat insulation ability of the string. Pressing of the outer pipe before installation in order to reduce curvature caused by heat transfer agent's temperature is an effortful technological and cost-based process which results in sufficient product price increase.

This invention is targeted at creation of heat insulated string segment that will possess high heat insulating properties.

Technical outcome provided by announced invention is the reducing of heat loss during heat-transfer agent passing the segment and improving of string service ability.

Heat insulated string segment contains inner pipe equipped with reinforcement on both ends, centralizers located on it, reflective insulation and gas absorbers; outer pipe with external thread on both ends produced with pressure isolated valve providing 10⁻⁴-10⁻³ mm of Mercury vacuum in an Interpipe space and a connecting coupling. In an Interpipe space there are steel insertions welded to inner and outer pipes with vacuum-tight seams, insertions are welded to the outer pipe at an area with external thread on its ends located under the length from first turn to thread main plane. In an Interpipe space steel insertions are located so that the groove of the insertions and outer pipe form hollow.

Steel insertions can be made in a form of spools.

Centralizers can be produced in a form of clamps consisting of at least two parts closely connected with each other, inner surface of it is produced with friction properties.

In an Interpipe space of the heat insulated string segment at an area with external thread on outer pipe ends on a segment located under the length from first turn to thread main plane there located steel insertions produced with the groove and welded to inner and outer pipes with vacuum tight seams. Insertions inner surface partly counterfits the surface of the reinforcements on inner pipe ends; and outer surface of the insertions partly counterfits the machined inner surface of the outer pipe.

Presence of abovementioned steel insertions mounted as described in an Interpipe space between the inner and outer pipes allows to perform sufficiently precise assembling of the string segment and simultaneous assembling of the reinforcement details for welding. Besides that a high quality welding is provided which improves the service ability of the heat insulated string and tightness of the outer pipes ends; all of this reduces bending during thread cutting and during operating of the string which assists to decrease string depressurization possibility.

Groove produced on each of steel insertions provides creation of hollow with outer pipe and allows to reduce active area of insertion contact with outer pipe and to reduce heat loss of the whole string by such measures.

Steel insertions are welded to outer pipe at an area with external thread on its ends on a segment located under the length from first turn to thread main plane. This is the area with where the string bears most deformation during operation and endures maximum load at make-up and break-out of the thread connection. This explains why steel insertions must be welded to outer pipe on this exactly area; it will reduce depressurization possibility of the string in places of its connection to the inner pipes and will improve service ability of the string in the whole.

Machining of the inner surface of outer pipe consists of fine boring of the outer pipe that has deviations from regular circle in its section and is performed in order to install steel insertion with round section between the pipes. Abovementioned machining is performed on a segment where steel insertions are located on the outer pipe surface segment located under outer pipe ends with external thread.

Performing of the reinforcement on the inner pipe ends provides additional tightness to the construction. Reinforcement can be made either in a form of upset shaped ends or in a form of a spool fixed on a pipe end.

Creation of the vacuum exceeding 10⁻³ mm of the Mercury with the help of pressure isolated valve located on an outer pipe does not provide sufficient reduction of heat loss through the interpipe space. Vacuum less than 10⁻⁴ mm of the Mercury demands additional power inputs for its creation along with that heat insulation quality of the string does not improve sufficiently and this makes it unreasonable.

High-activity metal absorbers titanium-based are used as gas absorbers located between the reflective insulation layers. Abovementioned gas absorbers are sintered tablets with developed porous structure and high absorbing capacity at temperatures within 25-400° C. range. Within this temperature range the absorbers gather hydrogen, nitrogen, water steams, oxygen, carbon dioxide.

The insulation of a heat conducting string is multi-layered and consists of separate insulation located under centrators solely and is necessary for insulation of the centrators from inner pipe surface, as well as of several layers of reflective insulation coiled over the inner pipe between centrators.

Steel insertions can be produced either in a form of spool or a ring. However spool-like insertions have bigger thickness against those in a form of ring, which provides additional tightness of the outer pipe during thread cutting and operation of the heat insulated string. This helps to reduce bending affecting the string and to prolong operation of the string.

Producing of each of centrators in a form of collar clamp consisting of least two semicircles closely connected with each other performing the inner surface of the centrators with friction properties (with roughness) enables to provide sufficient effort for attaching them to inner pipe through insulation which prevents centrators from shifting along the pipe during assembling; this excludes appearance of goffers on insulation and breaking of its integrity, besides that it reduces heat loss of the string.

The invention is described by drawings;

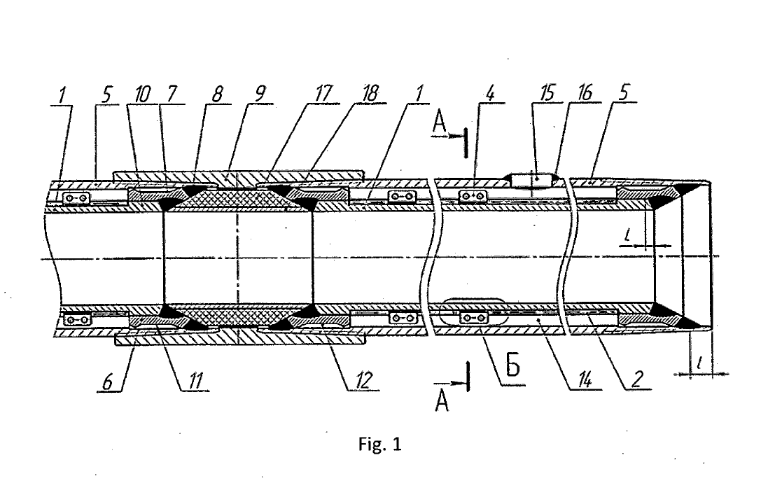

FIG. 1 depicts longitudinal section of heat insulated string;

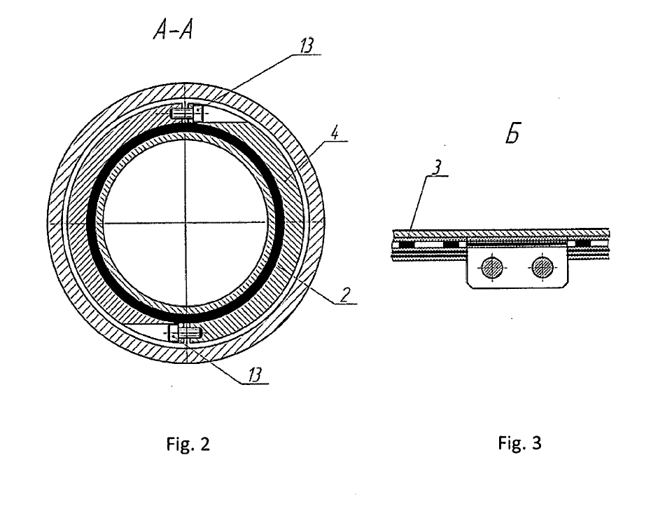

FIG. 2 depicts cross section A-A on FIG. 1; on

FIG. 3—B-view on FIG. 1: centrators location, insulation and gas absorbers on an inner pipe.

Heat insulated string segment contains inner pipe (1), reflective insulation coiled over it (2), between the layers of it there located gas absorbers (3), centrators (4), fixed on a separate insulation, outer pipe with external thread on its ends, connecting coupling (9). Inner pipe (1) and outer pipe (5) are connected by welding steel insertion (6) to pipes (1, 5) with vacuum-tight seams (7, 8). Inner pipe (1) is produced with reinforcements (10) on its ends. Inner surface of each of steel insertions (6) partly counterfits the reinforcement (10) surface of the inner pipe (1), and the outer surface of the insertions (6) partly counterfits with machined inside surface of the outer pipe (5) on a segment located under outer pipe (5) ends with cut external thread. Each steel insertion (6) is produced with groove (11) forming hollow (12) with outer pipe (5) and is welded to outer pipe (5) at an area with external thread on its ends on a segment located under the length from first turn to thread main plane.

Each of centrators (4) can be made in a form of collar clamp consisting of at least two semi-circles closely connected with each other for example with screws (13). Along with the inner surface of centrators is performed with friction properties. In an interpipe space (14) there is created vacuum by the means of valve (15) produced on an outer pipe (5) and welded round with vacuum-tight seam (16).

Outer pipes (5) of the spring segment are connected by the coupling (9) that is previously equipped with ferrule (17) produced of heat insulating material.

Heat insulating string segment is produced as described further. Centrators (4) produced in a form of collar clamp and consisting of two semicircles are placed onto inner pipe (1) on a separate insulation. The abovementioned insulation is set under centrators (4) solely and insulates them from inner pipe (1). Prior to this the inner surfaces of centrators' semicircles are given friction properties by means of cutting tool. The collar clamp semicircles are closely tightened with screws (13). This excludes appearance of burrs and goffers and breaking of insulation integrity.

Further on reflective insulation (2) is coiled over inner pipe (1) between centrators (4), gas absorbers (3) are located between the insulation layers (2). Further on inner pipe (1) with centrators (4) is inserted into outer pipe (5). After that steel insertions (6) are put into interpipe space (14), the insertions are to be welded onto a pipe at an area with the external thread on its ends on a segment located under the length from first turn to thread main plane; insertions are located provided that the groove of the insertion and the outer pipe create hollow.

Inner pipe (1) is welded with the vacuum-tight seams (7, 8) with outer pipe (5). Precision of pipe mounting and of mounting the details forming reinforcement area provide performing of high-quality welding and sufficient tightness of outer pipe ends. Groove (11) of the insertion (6), forming hollow (12) with outer pipe, (5) helps to reduce active area of the insertion contact with outer pipe. Welding of the insertion is performed at 1 length from outer pipe end face at an area with external thread on its ends on a segment located under the length from first turn to thread main plane. This increases tightness of thread connection and of the string in the whole, reducing the possibility of its depressurization during operation. Further on the air is pumped out from the interpipe space (14) through the valve (15) creating vacuum and activating gas absorbers (3) which excludes accumulation of gases in the interpipe space during operation of the string.

Gas absorbers (3) activation is provided by heating of the mounted string segments up to the temperature providing breaking of the oxide film from the gas absorber surface after what the absorbing of moisture and gas begins.

Outer pipes (5) are connected with each other after being equipped with external thread by a coupling (9) which is preliminary equipped with ferrule (17), produced of heat insulating material and pulled over steel pup-joint (18). Ready to operate string segments are collected and mounted into a string, are run into injection well and then pumping of the heat transfer agent in starts.

### EXAMPLE OF INVENTION PERFORMANCE

Heat insulating string was assembled according to FIG. 1. Pipe with 114.3 mm diameter and wall 7.37 mm thick, with reinforcements having 124 mm diameter at their ends (upset shaped ends), located on the pipe ends was used as an inner pipe. As an outer pipe a pipe with 168.28 mm diameter and wall 8.4 mm thick with machined inner surface located under threaded ends and having 153^{+0.53} diameter was used. Material for inner, outer pipes and for steel insertions—is steel with 32Γ2 grade. First the centrators consisting of two semicircles with roughness on its inner surface, with graduation line in particular, are put onto the inner pipe separate insulation—which is the layers of glass fiber reinforced grid and aluminum foil. Semicircles were tightened closely with screws which provided proof positioning of centrators on the inner pipe. Further on reflective insulation was coiled over the inner pipe, insulation consists of glass fiber reinforced grid and aluminum foil layers. Between the layers gas absorbers (getters) marked ΓΠ-T [symbol] I-O with 12 mm diameter and 2.5 mm thickness were placed. After that the inner pipe was put into the outer pipe, and the insertions with outside diameter 153_{-0.800}^{-0.260} mm and inside diameter 122 mm were inserted into interpipe space along the bearing face of the outer pipe with 153^{+0.53} mm diameter from both ends, interpipe space located under outside threaded ends. The inner surface of the insertions counterfitted surface of the inner pipe reinforcements with 1 mm per side gap and its outer surface counterfitted the outer pipe at a seat with guaranteed gap produced by a groove on insertion.

The welding was performed at an area with external thread on pipe ends on a segment located under the length from first turn to thread main plane 30±2 mm from outer pipe end face. Precision of assembling of pipes relative to each other and assembling of details composing reinforcement provided high quality welding; location of welded joint of the insertion with the outer pipe on a segment under the length from first turn to thread main plane, which is the area with the maximal thread load, provided required tightness of the outer pipe. The groove of the insertion forms hollow between its outer surface and an outer pipe reducing its active area of contact. Further on air was pumped out from the interpipe space through the valve located on the outer pipe creating 10⁻⁴-10⁻³ mm of the Mercury vacuum and activated gas absorbers by heating pipes up to 400° C.

After completion of external thread on an outer pipe, on one of its ends on half of the thread a coupling is screwed with outside diameter of 187.71 mm and inside diameter of 151.0 mm equipped it with a ferrule and screwed another pipe onto another coupling end. Pipes and segments made up like that form a string which is run into injection well and pump the heat-transfer agent in.

Offered heat insulated string segment construction will enable to reduce heat losses due to reduction of string depressurization possibility, improve its service ability and to reduce production costs.

1. Heat insulated string segment containing inner pipe produced with reinforcements on its ends, centrators located on it, reflective insulation and gas absorbers, outer pipe with external thread on its ends, produced with pressure isolated valve providing creation of 10⁻⁴-10⁻³ mm of Mercury vacuum in an interpipe space and connecting coupling distinguished by presence of steel insertions in an interpipe space, welded to both inner and outer pipes with vacuum-tight seams, providing steel insertions welded to an outer pipe at an area with thread on its ends, on a segment located under the length from first turn to thread main plane, steel insertions are located in an interpipe space so as to provide groove produced on an insertion create hollow with an outer pipe.

2. Heat insulated string segment as defined in claim 1, distinguished by presence of steel insertions made in a form of hollow bar.

3. Heat insulated string segment as defined in claim 1, distinguished by centrators made in a form of clamps consisting of at least two parts closely tightened with each other, with inner surface made with friction properties.

4. Heat insulated string segment as defined in claim 2, distinguished by centrators made in a form of clamps consisting of at least two parts closely tightened with each other, with inner surface made with friction properties.
